(19) United States
(12) Patent Application Publication
(10) Pub. No.: US 2005/0031749 A1
(43) Pub. Date: Feb. 10, 2005

(54) Method of producing ready-to-cook and pre-cooked food products

(75) Inventor: Gari R. Church, Lawrenceville, GA (US)

Correspondence Address: WOMBLE CARLYLE SANDRIDGE & RICE, P.O. Box 7037, Atlanta, GA, 30357-0037, US

(73) Assignee: GariMark

(21) Appl. No.: 10/911,089

(22) Filed: Aug. 4, 2004

Related U.S. Application Data
(60) Provisional application No. 60/492,417, filed on Aug. 4, 2003.

(51) Int. Cl. A23L 1/31

(52) U.S. Cl. 426/512

(57) ABSTRACT

A process for producing sliced, easy to prepare, prepackaged food products, in which a food mix is prepared from a meat or other food product mixed with a marinade solution. The food mix is formed into a product log, chilled and sliced to form product slices or chips of a desired size and weight. Thereafter, the product slices can be breaded, cooked and frozen for packaging and shipment.

### CROSS REFERENCE TO RELATED APPLICATIONS

The present application claims priority to U.S. Provisional Patent Application Ser. No. 60/492,417, filed Aug. 4, 2003.

### FIELD OF THE INVENTION

The present invention generally relates to systems and methods of processing and preparing ready-to-cook and pre-cooked food products, and, in particular, to a method of producing a ready-to-cook and pre-cooked meat product, such as a breaded chicken portion, that provides greater product uniformity and consistency with improved production rate at a lower cost.

### BACKGROUND OF THE INVENTION

Processed ready-to-cook and pre-cooked foods such as chicken wings, chicken tenders, chicken nuggets, popcorn chicken, chicken breast strips, chicken chunks (boneless chicken wings), etc. have become extremely popular for sale in restaurants and for home consumption. The volume of sales have accordingly steadily grown in the last several years. Such ready-to-cook and pre-cooked food items generally provide restaurants with tasty, easy-to-prepare appetizers that can be quickly cooked and served as a precursor to a meal, while the entrée is being prepared. In addition, there is a growing preference by consumers for new conveniently prepared and served “appetizer” type foods, such as chicken strips or tenders, chicken nuggets, etc., that can be purchased at casual dining, quick service, or retail/grocery outlets. Consequently, it has been known for some time how to prepare foods such as chicken tenders or chicken wings by marinating, breading, and frying them before freezing them for shipment.

There is a need, however, for manufacturing processes for such whole muscle ready-to-cook and pre-cooked food articles that provide substantially uniform weights and quality of such food articles. For example, most consumers prefer breast meat for chicken tenders, which generally requires that the breast meat be stripped from the breastbone of a chicken and then cut into strips that are marinated, breaded and then fried. However, such strips typically cannot be cut uniformly, thus resulting in variations in weight and size of the strips. This makes it difficult to accurately and consistently produce and package desired quantities of breast strips, or similar food articles, by weight. In addition, because of such food product variability, it is typically necessary to cook the portions or batches of such products for a time sufficient to thoroughly cook the largest breast strips of a batch, to ensure that cooking quality and health standards are met. However, this can lead to smaller pieces being over-cooked or larger pieces sometimes undercooked, causing consumer dissatisfaction and compromised food safety.

Accordingly, it can be seen that a need exists for an improved process for preparing ready-to-cook and pre-cooked food articles that addresses the foregoing and other related and unrelated problems in the art.

### SUMMARY OF THE INVENTION

Briefly described, the present invention provides a process for preparing ready-to-cook and pre-cooked food products, especially meat products, having substantially uniform size, shape and weight characteristics and which allow for reduced manufacture and finish preparation time. The food mixes prepared according to the present invention generally, but not only, are meat mixes, such as chicken products, that are marinated, stuffed into a casing, chilled to a desired temperature range to facilitate slicing and pickup of a batter/breading, and sliced into food products that can then be coated with a breading system before being partially or completely cooked, with the resultant food products being of a substantially uniform size, thickness and weight. Typically, the food products will have a sufficient surface area, temperature, and shape or configuration that enables the products to more readily be coated with a batter mix and breading material applied thereto in fewer passes along a breading line or station, thereby allowing a reduction in the amount of meat necessary for achieving a desired weight and size for the resultant food products. The uniformity of the product slices is desirable for providing to the consumer a predictable amount of product having a consistent quality.

Various objects, features and advantages of the present invention will become apparent to those skilled in the art upon reading the following detailed description in conjunction with the accompanying drawings.

### DETAILED DESCRIPTION OF THE INVENTION

The present invention is generally directed to a process for preparing ready-to-cook and pre-cooked food products having substantially uniform size, shape and weight characteristics and which allow for reduced manufacture time. In particular, the present invention as described below has particular application to the preparation or formation of breaded ready-to-cook and pre-cooked meat products, utilizing the meat from chickens, turkey or other fowl. However, it also will be understood that the present process has application to the preparation of other food articles incorporating various other meat products, such as beef, pork and lamb, as well as fish, or combinations thereof. It is also within the scope of the invention for the meat to be partially or completely cooked before mixing with the marinade. In addition, the process of the invention is suitable for preparing vegetable-based food products, such as tofu or other soy or vegetable products, wherein some or all of the meat in the food mix is substituted by one or more vegetables.

In one example embodiment of the present invention for preparing sliced, breaded, ready-to-cook or pre-cooked food products from meat such as chicken, as an initial step, a meat product mixture is formed in which the chicken or other meat is trimmed and mixed with a marinade. Typically, chicken breast meat will be used after being de-boned or otherwise removed from the poultry carcass, with any fat skin and other undesirable tissues being trimmed away. The breast meat is combined with the marinade solution and is mixed in a vacuum tumbler that applies a vacuum to the meat as it is tumbled and mixed with the marinade solution as needed to thoroughly infuse the breast meat with the marinade. An example marinade solution can include water, sodium phosphate and sodium chloride, mixed in a solution of approximately 80-90%, by weight, water; 4-8%, by weight, sodium chloride; and 2-6%, by weight, sodium phosphate. A variety of seasonings and/or flavorings may also be included in the marinade as desired to provide different flavors or tastes to the food product. The vacuum tumbler typically is run for approximately 20-40 minutes, most typically, for about 30 minutes at 8 rpms, and will apply a vacuum of approximately 20-30 mm Hg. It will however, be understood that the amount of vacuum and the timing of the tumbling of the meat mixture in the vacuum tumbler can be varied as needed or desired for sufficiently infusing the meat with the marinade solution.

After the product meat has been marinated to the desired degree, the marinated meat product mixture is transferred to a traditional sausage or casing vacuum stuffing system, such as a Vemag 500® continuous stuffer, which is a double screw vacuum stuffer machine. The marinated product meat mixture is stuffed into a casing, such as a Viskase® casing or other similar type of food product casing as will be known in the art, under vacuum through the stuffer to form a substantially cylindrical stuffed casing or product log having a desired diameter or width. For example, the product log can be formed having a diameter from about 1 inch to about 3 inches, although a greater or larger diameter product log also can be formed as desired, and generally will be approximately 1000 mm or less in length for ease of handling and to fit a downstream slicing station. It will, however, also be understood by those skilled in the art that further variations in the diameter and/or length (i.e., a smaller diameter or length greater than 1000 mm) of the product log further can be made as desired.

After the casing of the product log has been clipped, tied, or otherwise secured, the product log will be stacked on racks or “chilling shelves” and will be transferred into a chilling room in which the product log is lowered to a temperature of between about 15° F. and about 30° F. The product typically will be left within the chilling room for a sufficient time to chill the meat product log throughout to a temperature of approximately 20° F.-24° F. The temperature of each product log can be checked using monitors such as thermometers or thermocouples inserted in the product logs to ensure the desired temperature range is met.

The chilled product logs may be stored at the chilling temperature or immediately taken to a slicer, such as a Dixie Unislicer®, in which one or several product logs, depending upon the diameters of the logs, can be placed on a support or slicing shelf for the slicer. The blade of the slicer will be adjusted to slice the chilled breast meat product logs to form slices or “chips” of a desired thickness. In one embodiment of the process, the product slices can have a thickness of between about 2 mm to about 5 mm, although the slices also can be formed in greater or lesser thicknesses as desired.

The chilling of the product logs before slicing helps hold the meat product mix together during slicing. The resultant sliced product “chips” will have a uniform thickness, diameter and weight per slice. For example, using the process of the present invention, “chicken chips” can be formed and sliced with a thickness of approximately 3.5 mm, a diameter of approximately 50 mm, and a weight of between about 4 gms and about 4.75 gms. The chips can be further sliced, stamped or cut into other desired shapes or configurations, other than round, such as, but not limited to, triangles, squares, octagons and the like.

The product slices or chips typically are then conveyed to a breading line or station in which the chips are battered, breaded, and thereafter passed through a cooking station to oil set or fully cook the breaded sliced products. The disc shape, cold temperature, and increased surface area of the product slices enables enhanced and faster batter and breading pickup by the slices as they pass along the breading line. As much as about 50% or more breading pickup can be accomplished in fewer passes, for instance, passes, as compared to the level of breading pickup and number of passes typically required for irregularly shaped chicken tenders, nuggets, patties, or other similar products. It is also possible to substantially reduce or eliminate the batter or breading operation and pass the product slices straight to a cooking line such as a fryer or oven.

It is contemplated that the battered and breaded product slices also can be heated and cooked along a cooking or heating line to a variety of degrees or amounts before packaging, according to their intended use by the consumer. For example, the slices may be heated to set the batter, while the underlying meat mix is not sufficiently cooked for immediate consumption. The product slices may be heated to a desired pre-cooked state, whereby the consumer is required to thaw the slices and continue the cooking process to completion. The product slices may also be cooked to a state for immediate consumption once the frozen product is thawed and warmed. Typically, a frying station employing a vegetable oil such as soybean oil may be used, although other types of cooking oils also can be used. Alternatively, the battered and breaded products could be oven-baked.

After the sliced product chips have been breaded and cooked, they generally will be transferred into a freezer in which they will be subjected to temperatures as low as approximately −10° to approximately +10° Fahrenheit so as to freeze the products. The frozen product can then be packaged into various size bags and cases. The meat products additionally are generally subjected to quality control checks or inspections, such as passing the products through a metal detector and conducting random sample testing, including microbiological screening, before ultimately being packaged in cases (e.g., a 10 lb. case wherein 10, 1-lb. bags will be placed in each box or case) which are date coded and labeled. The finished, packaged products can then be loaded into a freezer truck for shipment, or can be transferred to a storage freezer for storage until transported to customers.

The resultant sliced, chip products formed by the present invention thus generally are substantially consistent or uniform in terms of size, shape, and weight, which enables them to be cooked substantially uniformly for a reduced time (for example, a serving of the meat products of the present invention can be cooked in about 60 seconds to two minutes as opposed to as much as 10 minutes for irregularly shaped products). The uniformly sized products can be conveniently metered or divided into portions of a consistent size, weight, and number at the point of service to the consumer.

The following charts disclose example testing and quality control procedures for the food products of the present invention.

### EXAMPLE 1

### Unacceptable Product Slices, After Cooking

| Rejection Criteria | Tolerance |
|---|---|
| Folded Chips | 0 defects |
| Marriages (2 or more | 0 defects |
| portions attached) | |
| Undercooked | 0 defects |
| Breading voids | No more than 2% by |
| | count or less than a |
| | dime size area along |
| | the product |

### EXAMPLE 2

### Processing Parameters for the Meat Products of the Present Invention

| Parameter | Target | Range | Method |
|---|---|---|---|
| Marinade | Up to 15% by | 10-18% | Calculation |
| Pickup | weight | | |
| Breading | Up to about | 48-52% | Calculation |
| pickup | 50% | | |
| Metal | 2.5 mm non ferrous | 2.5 mm non ferrous | Line check |
| detection | and 2.0 mm ferrous | and 2.0 mm ferrous | |
| | quantity | | |

### EXAMPLE 3

### A Product Chip Formed by the Process of the Present Invention

| | | | Standard |
|---|---|---|---|
| | | | Control |
| Standard | Target | Range | Method |
| Raw portion | 4.75 grams | 4.5-5.0 grams | Direct |
| weight | | | Measurement |
| Raw portion | 95/lb. | 90-100/lb. | Direct |
| count | | | Measurement |
| Finished | 9.5 grams | 9.0-10.0 grams | Direct |
| portion weight | | | Measurement |
| Finished | 47.75/lb. | 45.36-50.4/lb. | Measurement |
| portion count | | | |
| Color: Fryer | To be determined | To be determined | SE Mills Color |
| recon | by customer | by customer | Chart |
| | preference | preference | |
| Organoleptic | No undesirable | | Subjective |
| | odors or flavors | | testing |
| Foreign objects | None | | Visual/Line |
| | | | Inspection |

### EXAMPLE 4

### Sampling or Quality Control Procedures Applied to the Meat Product-Forming Process

a. Visual inspection and weighing of 10-20 product slices every 20-30 minutes for deviation from the desired product standards as given in Example 3 above;

b. Counting at least one sample case of product approximately every 30-60 minutes to ensure product uniformity and consistency;

c. Periodic cooking of samples of product slices for color and organoleptic evaluation.

It accordingly will be understood by those skilled in the art that while the foregoing process has been described with reference to preferred embodiments above, various changes, additions and modifications can be made thereto without departing from the spirit and scope of the invention.

1. A process for forming a food product comprising:
forming a food product mix;
forming the food product mix into a product log;
cooling the product log to a desired temperature;
slicing the product log into substantially uniform product slices having a desired thickness;
breading the product slices;
cooking the product slices; and
freezing the product slices.

2. The process according to claim 1, wherein the food product mix comprises a meat mix of poultry meat, pork meat, lamb meat, beef, or fish or combinations thereof.

3. The process according to claim 2, wherein the food product mix further comprises a marinade.

4. The process according to claim 3, wherein forming the meat product mix comprises introducing the marinade to the meat mixture under a vacuum.

5. The process according to claim 1, wherein the food product mix comprises poultry breast meat.

6. The process according to claim 1, wherein the food product mix comprises a vegetable product mixed with a marinade.

7. The process according to claim 1, wherein forming the food product mix into a product log comprises delivering the food product mix into a casing.

8. The process according to claim 1, wherein the product log is cooled to at least about 25° Fahrenheit.

9. The process according to claim 1, wherein the product slices are each between about 1 mm and about 1 cm in thickness.

10. The process according to claim 1, wherein breading the product slices comprises coating the product slices with a batter mix, and coating the battered product slices with a breading mix.

11. The process according to claim 1, wherein cooking the product slices comprises frying or baking the product slices.

12. The process according to claim 1, wherein cooking the product slices comprises cooking the product slices to a desired condition for consumption by a consumer.

13. The process according to claim 1, further comprising inspecting the product slices for contamination.

14. A process for forming a meat product for easy preparation and consumption, comprising:
forming a meat product mix comprising a meat and a marinade;
forming the meat product mix into a product log by delivering the meat product into a casing;
cooling the product log in a chiller to at least 30° F.;
slicing the cooled product log into substantially uniform product slices, said slices having a desired thickness of between about 2 mm and about 1 cm;
cooking the product slices until the batter mix is substantially set; and
freezing the product slices.

15. The process of claim 14 and further comprising breading the product slices by coating the product slices with a batter mix and a breading mix;

16. The process according to claim 14, wherein the forming the meat product mix comprises mixing poultry breast meat with the marinade under a vacuum.

16. The process according to claim 14, further comprising heating the product slices to a pre-cooked state.

17. The process according to claim 14, wherein cooking the product slices comprises cooking the product slices to a condition suitable for immediate consumption of the slices by a consumer.

18. A food product comprising substantially uniform product slices prepared according to the method of claim 1.
